(19) United States
(12) Patent Application Publication
(10) Pub. No.: US 2012/0211012 A1
(43) Pub. Date: Aug. 23, 2012

(54) Method and Apparatus for Covering Body Parts

(76) Inventor: Andrea Niemiec, Westlake Village, CA (US)

(21) Appl. No.: 13/372,495

(22) Filed: Feb. 14, 2012

Related U.S. Application Data
(60) Provisional application No. 61/463,203, filed on Feb. 14, 2011.

(51) Int. Cl. A61J 13/00

(52) U.S. Cl. 128/890

(57) ABSTRACT

A method and apparatus for covering body parts. Body part covers may be pre-shaped and pre-sized to cover various parts of one's body, or may be fabricated in a generic shape, and cut by the user to a custom shape of the user's choice. Body part covers may also include lettering on one or more surfaces of the body part cover. The lettering may be implemented as text, words, abbreviations, messages, symbols, graphics, designs, phrases and the like. The body part cover may also include an additive such as a scent or fragrance, for example, or may be implemented as scented or unscented copulins or pheromones.

### RELATED APPLICATIONS

This application claims priority to U.S. Provisional Application Ser. No. 61/463,203, filed on Feb. 14, 2011, which is incorporated herein by reference.

### BACKGROUND

1. Field

The present invention relates to a method and apparatus for covering body parts.

2. Related Art

Traditional body part coverings have generally been used as protective mechanisms, such as to prevent clothes from rubbing up against a sensitive body part or to prevent clothes from chafing a particular area of the body. For example, covers for breast nipples are most commonly used to protect the nipples from chafing when going braless or doing physical exercise.

Alternatively, body part coverings have been used to conceal various body parts. For example, covers for breast nipples are commonly used to conceal the nipples from protruding away from the breasts under form fitting clothes.

Thus, given that many traditional body part coverings have been used to cover private parts of one's body, body part coverings have traditionally been a means by which attention is diverted away from and discussion is precluded about the particular body part being covered. However, this diversion of attention and preclusion of discussion can be frustrating for those that want to attract attention and possibly generate conversation with others, such as members of the opposite sex.

Thus, there is a need for a method and apparatus for covering body parts that is capable of generating conversation and bringing attention to specific parts of one's body.

### SUMMARY

The present invention is a method and apparatus for covering body parts.

According to an embodiment of the present invention, a body part cover may be pre-shaped and pre-sized to cover various parts of one's body, such as a breast nipple, for example. The body part cover may be shaped in various known configurations. For example, in one embodiment, the body part cover may be heart-shaped. Other examples of pre-shaped body part covers may include star-shaped covers, circular-shaped covers, oval-shaped covers and the like. Alternatively, according to an embodiment of the present invention, the body part cover may be fabricated in a generic shape, such as a square, for example, and cut by the user to a custom shape of the user's choice. The body part cover may also be fabricated in a slightly concave, or cup-shaped, manner.

An embodiment of the body part cover may also include lettering or designs on one or more surfaces of the body part cover. For example, according to an embodiment of the present invention, the lettering or design may be positioned on an inner surface or an outer surface of the body part cover. The lettering may be implemented as text, words, abbreviations, messages, phrases and the like.

According to the embodiment of present invention, the body part cover may also include an additive such as a scent or fragrance, for example. The additive may be implemented with a variety of different perfumes or fragrances. The additive may also be implemented in the form of essential oils, for example. If the additive is implemented as a scent, the scent may be spicy, flowery, fruity, candy-related, dessert-related and the like.

Embodiments of the present invention may include additives such as scented or unscented copulins or pheromones. Alternatively, copulins or pheromones may be included with a scent or fragrance such that the scent or fragrance becomes a pheromone-enhanced additive.

Embodiments of the invention may include an apparatus for covering a body part comprising a cover element having a surface area, the surface area sized sufficiently to cover a part of a body, wherein the cover element includes lettering. The cover element may be pre-shaped or pre-sized. Embodiments of the invention may also include a method for covering a body part comprising providing a cover element having a surface area, the surface area sized sufficiently to cover a part of a body, wherein the cover element includes lettering.

The preceding and other features of the invention will become further apparent from the detailed description that follows. Such description is accompanied by a set of drawing figures. Numerals of the drawing figures correspond to numerals of the written description with like numerals referring to like features throughout both the written description and the drawing figures.

### BRIEF DESCRIPTION OF THE DRAWINGS

The features, objects, and advantages of the present invention will become more apparent from the detailed description set forth below when taken in conjunction with the drawings, wherein:

FIG. 1 is a front elevation view of an embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Furthermore, any reference to singular includes plural embodiments, and any reference to more than one component may include a singular embodiment.

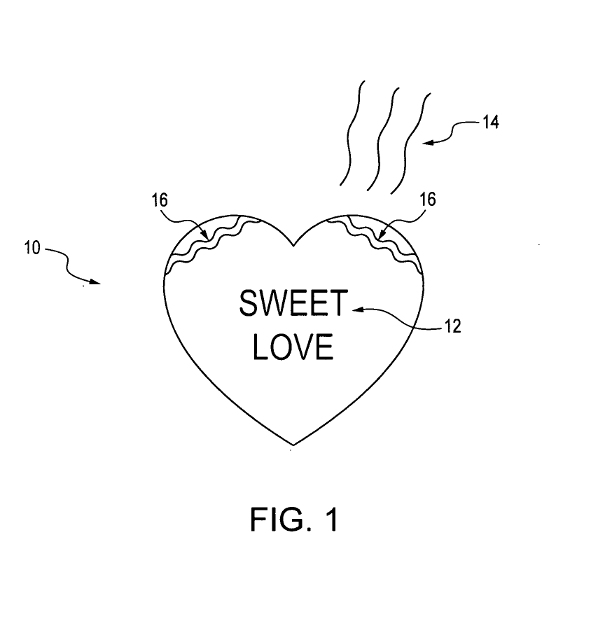

FIG. 1 shows a body part cover 10 according to an embodiment of the present invention. The body part cover 10 shown in FIG. 1 may be pre-shaped and pre-sized to cover various parts of one's body, such as a breast nipple, for example. The body part cover 10 may be shaped in various known configurations. For example, the embodiment shown in FIG. 1 shows a heart-shaped body part cover 10. Other examples of pre-shaped body part covers 10 may include star-shaped covers, circular-shaped covers, oval-shaped covers and the like. Alternatively, according to an embodiment of the present invention, the body part cover 10 may be fabricated in a generic shape, such as a square, for example, and cut by the user to a custom shape of the user's choice. The body part cover 10 may also be fabricated in a slightly concave, or cup-shaped, manner to facilitate application of the invention to various parts of the body, such as a breast nipple, for example.

According to embodiments of the present invention, the body part cover 10 may also be fabricated from a variety of fabrics or materials. For example, the body part cover 10 may include any type of decorative pattern 16. In addition, the body part cover 10 may be fabricated out of materials that shimmer or contains sparkles, for example. The body part cover 10 may also be made out of fabrics or materials that come in a variety of colors.

The body part cover 10 shown in FIG. 1 may be fabricated in a pre-sized manner to facilitate covering various body parts. For example, the body part cover 10 may be pre-sized to cover breast nipples, although breast nipples are only one example for which embodiments of the present invention may be used. The body part cover 10 may also be used to cover moles, birth marks and the like.

Embodiments of the body part cover 10 shown in FIG. 1 may include an adhesive for application to one's body. The adhesive may be silicon, for example, and may be reusable or may be a one-time adhesive. Embodiments of the body part cover 10 may implement an adhesive on a surface of the body part cover 10 that faces a user's skin. However, if an embodiment of the body part cover 10 were to be used to cover a breast nipple, for example, a portion of a surface of the body part cover 10 that faces the breast nipple may be free of adhesive and may include a soft center. In this example, an adhesive could be applied to the portions of the body part cover 10 that are adjacent to the portion of the body part cover 10 that directly faces the breast nipple.

The embodiment of the body part cover 10 shown in FIG. 1 may also include lettering or designs 12 on one or more surfaces of the body part cover. For example, according to an embodiment of the present invention, the lettering 12 may be positioned on an inner surface or an outer surface of the body part cover 10. The lettering or design 12 may be implemented as text, words, abbreviations, messages, symbols, graphics, designs, pictures, phrases and the like. For example, the lettering or design 12 may be implemented to read things like “Big Flirt” or slang abbreviations like “OMG.” Any font or size lettering or design 12 may be used on the body part cover 10.

The lettering 12 may be applied to the body part cover 10 in a variety of ways. For example, according to an embodiment of the present invention, the lettering 12 may be applied to the body part cover 10 by printing. Other methods by which the lettering 12 may be applied to the body part cover 10 include embossing, imprinting, stamping, dying, gluing, tattooing and the like.

According to an embodiment of the present invention, the body part cover 10 may contain one or more written messages, allowing users to create or express their own personal message and generate conversation. Moreover, a user may mix and match body part covers 10 that have been implemented with different words or phrases to create a message. For example, a user may create a message by using a plurality of body part covers 10 on his or her body. If, for example, a user were to use body part covers 10 to cover breast nipples, one body part cover 10 covering one breast nipple may be chosen with the words “I Love You” while another body part cover 10 covering the other breast nipple may be chosen with the words “Many Me.” As another example, one body part cover 10 covering one breast nipple may be chosen with the words “Text Me” while another body part cover 10 covering the other breast nipple may be chosen with the words “You Rock.” As yet other examples, body part cover 10 pairs may include the words “You and Me” and “Sweet Love;” “Lover Boy” and “4 Ever;” and the like. Thus, using embodiments of the present invention, users may utilize the body part cover 10 to communicate or generate conversation.

According to the embodiment of present invention shown in FIG. 1, the body part cover 10 may also include an additive 14 such as a scent or fragrance, for example. The additive 14 may be implemented with a variety of different perfumes or fragrances. The additive 14 may also be implemented in the form of essential oils, for example. If the additive 14 is implemented as a scent, the scent may be spicy, flowery, fruity, candy-related, dessert-related and the like.

Embodiments of the present invention may include additives 14 such as scented or unscented copulins or pheromones. Alternatively, copulins or pheromones may be included with a scent or fragrance such that the scent or fragrance becomes a pheromone-enhanced additive 14 that may help attract the opposite sex. Thus, according to embodiments of the present invention, a body part cover 10 may include one or more additives 14 and may be scented with a fragrance, or scented with a pheromone-enhanced fragrance. Alternatively, the additive 14 may be an unscented pheromone.

While this invention has been described with reference to its presently preferred embodiments, it is not limited thereto. Various modifications to these embodiments will be readily apparent to those skilled in the art, and the principles defined herein may be applied to other embodiments without departing from the spirit or scope of the disclosed method and apparatus. The described embodiments are to be considered in all respects only as illustrative and not restrictive and the scope of the invention is, therefore, indicated by the appended claims rather than by the foregoing description. Rather the invention is limited only insofar as it is defined by the following set of patent claims and includes within its scope all equivalents thereof.

What is claimed is:

1. An apparatus for covering a body part comprising:
a cover element having a surface area, the surface area sized sufficiently to cover a part of a body,
wherein the cover element includes lettering.

2. The cover element of claim 1, wherein the cover element is pre-shaped.

3. The cover element of claim 2, wherein the pre-shaped cover element is a heart shape.

4. The cover element of claim 1, wherein the cover is pre-sized.

5. An method for covering a body part comprising:
providing a cover element having a surface area, the surface area sized sufficiently to cover a part of a body,
wherein the cover element includes lettering.
